(19) United States
(12) Patent Application Publication
(10) Pub. No.: US 2006/0140129 A1
(43) Pub. Date: Jun. 29, 2006

(54) Method for increasing amount of a data packet

(75) Inventor: Yi-Ming Wang, Zhudong Town (TW)

Correspondence Address: BRUCE H. TROXELL, SUITE 1404, 5205 LEESBURG PIKE, FALLS CHURCH, VA, 22041, US

(73) Assignee: Accton Technology Corporation

(21) Appl. No.: 11/230,573

(22) Filed: Sep. 21, 2005

(30) Foreign Application Priority Data
Dec. 23, 2004 (TW) 93140205

(51) Int. Cl. H04L 12/26; H04L 12/28; H04L 12/56; H04J 1/16

(52) U.S. Cl. 370/241; 370/390; 370/395.53

(57) ABSTRACT

A method of configuring at least a switch for duplicating a data packet and enabling the switch to output a plural duplicated data packets at a speed and volume qualifying for testing a device-under-test (DUT) is disclosed. The method comprising the steps of: dividing the switch into a first segment and a second segment, each having a plurality of ports, wherein one port of the first segment is assigned as an input port and one port of the second segment is assigned as an output port; defining the first segment to be a virtual LAN (VLAN) and second segment to be another VLAN; corresponding all the ports other than the input port in the first segment to all the ports other than the output port in the second segment in a one-on-one manner; inputting a set of data to the input port, wherein the set of data is transmitted to all the ports other than the input port in the first segment, and then each port of the first segment transmits the received set of data to the corresponding port of the second segment, and thus the output port of the second segment received a plural sets of data respectively transmitted from each port of the second segment other than the output port; and outputting the plural set of data from the output port.

### BACKGROUND OF THE INVENTION

1. Field of Invention

The present invention relates to a method for increasing amount of a data packet, and more particularly, to a method of configuring at least a switch for duplicating a data packet and enabling the switch to output the plural duplicated data packets at a speed qualifying for testing a hub, a switch and the like.

2. Related Art

Computer networks can be the most important product in the late 20th century and can be anticipated of having more applications in the coming years. In general, most enterprises or organizations have their own local area networks (LANs), which is a group of computers and associated devices that share a common communications line or wireless link and typically share the resources of a single processor or server within a small geographic area (for example, within an office building), for enabling communication within the enterprise or organization. However, these LANs may only connect to one another with the provision of the Internet. To enable the connection of a group of computers and associated devices so as to form a LAN, a variety of networking equipment having different functions is required, such as repeaters, hubs, bridges, switches, routers, gateways and the like. Depending on the requirements and scale of the LAN, each piece of the networking equipment has its particular function and cost and which of them are used is thus determined.

To become marketable commercial products, each of the above-mentioned networking equipment has to be tested during the manufacturing process thereof. One conventional method for testing typical hubs or switches with comparably fewer ports (e.g. two to four ports) may be seen in FIG. 1, where all ports are tested manually. As seen in FIG. 1, each port of a device-under-test (DUT) 13 (e.g. a hub) is connected to a plurality of LAN cards 12 installed in a computer 11 and is determined as normal while a testing packet generated by the computer 11 corresponding to the referring port is transmitted to the port of the DUT 13 via a cable and further is normally received and responded by the same port, otherwise is determined as abnormal. Apparently, a disadvantage of the foregoing testing method is that it is costly and difficult to maintain since the method requires many computers 11 to accomplish.

When number of the ports of the hub are increased, the method mentioned above is insufficient. Accordingly, another testing device, a relay box 23, for the hub is developed. The relay box 23 is a testing device operated under programmable control as shown in FIG. 2. In testing a DUT (e.g. the hub 24), at least one computer 21 is provided which generates testing data packets through a LAN card 22. The relay box 23 uses switch the testing data packets among ports of the DUT 24. As such, a better result is obtained. However, this testing device may not keep up with the continually growing speed of the hub, which has grown to 10 GMbps from the current specification of 10 M/100 Mbps, and the thus-generated testing data packets may not be sufficient for the high speed hub any more.

Since the prior testing device has an badly insufficient speed and is incapable of testing whether a failure is taken place in the network equipment and since devices exclusively for testing hubs or switches are too pricy, how to increase amount of data flow of the network devices and efficiently reduce the cost of the exclusive device can be the important issues in the development of today network equipment.

### SUMMARY OF THE INVENTION

It is, therefore, an object of the present invention to provide a method for increasing data flow, capable of duplicating a data packet in a rapid manner so as to meet a testing requirement.

It is another object of the present invention to provide a method of configuring at least a switch for duplicating a data packet and enabling the switch to output the plural duplicated data packets at a speed and volume qualifying for testing a hub, a switch and the like.

It is yet another object of the present invention to provide a method of increasing a speed of data packet duplication by a serial-connection manner so as to meet a testing requirement.

To achieve the above objects, the method of configuring a switch for duplicating a data packet and enabling the switch to output the plural duplicated data packets at a speed and volume qualifying for testing a device-under-test (DUT), comprising the steps of:
(1) dividing the switch into a first segment and a second segment, each having a plurality of ports, wherein one port of the first segment is assigned as an input port and one port of the second segment is assigned as an output port;
(2) defining the first segment to be a virtual LAN (VLAN) and second segment to be another VLAN;
(3) corresponding all the ports other than the input port in the first segment to all the ports other than the output port in the second segment in a one-on-one manner;
(4) inputting a set of data to the input port, wherein the set of data is transmitted to all the ports other than the input port in the first segment, and then each port of the first segment transmits the received set of data to the corresponding port of the second segment, and thus the output port of the second segment received a plural sets of data respectively transmitted from each port of the second segment other than the output port; and
(5) outputting the plural sets of data from the output port.

### BRIEF DESCRIPTION OF THE DRAWINGS

FIG. 1 is a schematic diagram illustrating a prior testing device.

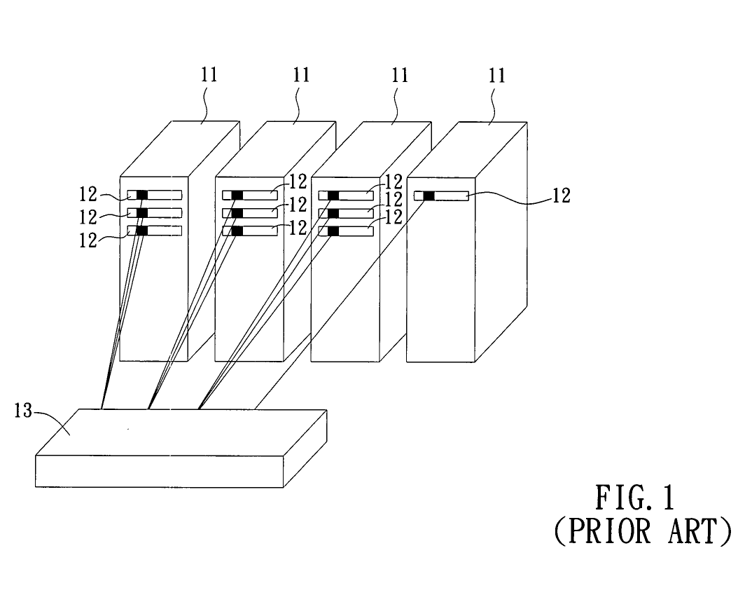

FIG. 2 is a schematic diagram illustrating another prior testing device.

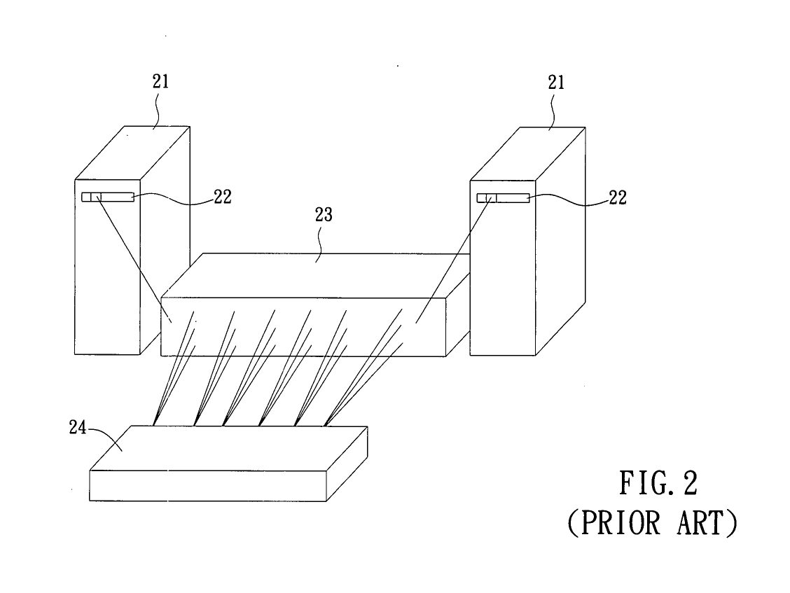

FIG. 3 is a schematic diagram illustrating a port configuration of a switch according to an embodiment of the present invention.

FIG. 4 is a schematic diagram illustrating a relationship between a data flow and the port configuration of the switch according to an embodiment of the present invention.

FIG. 5A is a schematic diagram illustrating an embodiment of the present invention.

FIG. 5B is a schematic diagram illustrating another embodiment of the present invention.

FIG. 6 is a flowchart of the present invention.

### DETAILED DESCRIPTION OF THE INVENTION

For your esteemed members of reviewing committee to further understand and recognize the fulfilled functions and structural characteristics of the invention, several preferable embodiments cooperating with detailed description are presented as the follows.

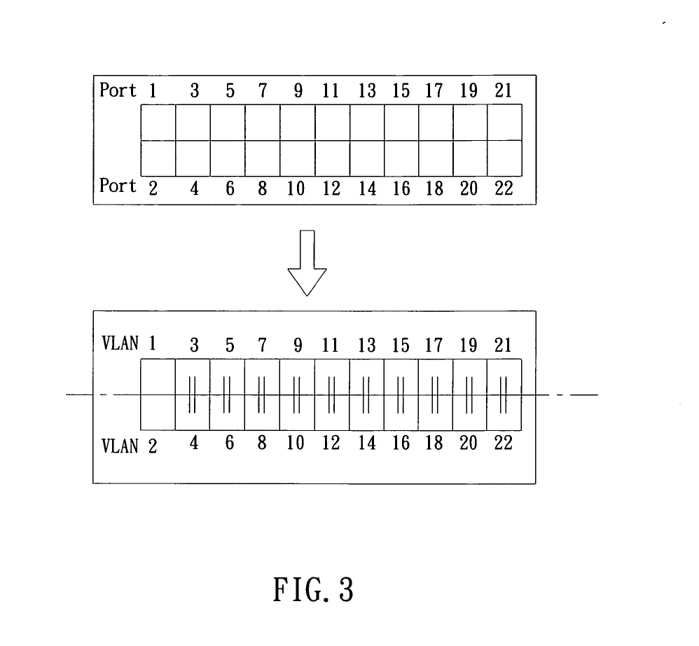

Referring to FIG. 3, a schematic diagram of port configuration of a switch according to an embodiment of the present invention is illustrated therein. In this embodiment, the switch has 22 ports, being equally divided into and arranged at an upper portion with odd-numbered ports and a lower portion with even-number ports, which the upper and lower portions of the switch are respectively assigned as a first segment with a port 1 assigned as an input port and a second segment with a port 2 assigned as an input port.

Also, virtual local area network (VLAN) technology is utilized as to define the ports of the first segment as VLAN1 and the ports of second segments as VLAN2. By virtual of this, data inputted through the input port, i.e. port 1, may be broadcast to the ports in VLAN1 other than the input port (hereinafter referred to as non-input ports in VLAN 1), and the ports of VLAN2 other than the output port (hereinafter referred to as non-output ports in VLAN 2) are enabled to transmit data to the output port of the VLAN2, i.e. port 2.

Moreover, the non-input ports in VLAN 1 are corresponded to the non-output ports in VLAN2 by a one-on-one manner so that the data inputted to the input port may be transmitted to VLAN2. Further, in this embodiment, port 3 is connected with port 4, port 5 is connected with port 6, . . . , and port 21 is connected to port 22, and the rest may be deduced by analogy. So that, the data inputted from port 1 is being broadcasted to port 3, port 5, . . . , and port 21 and then may be transmitted from port 3 to port 4, from port 5 to port 6, . . . , from port 21 to port 22. As such, the port configuration of the switch is completed.

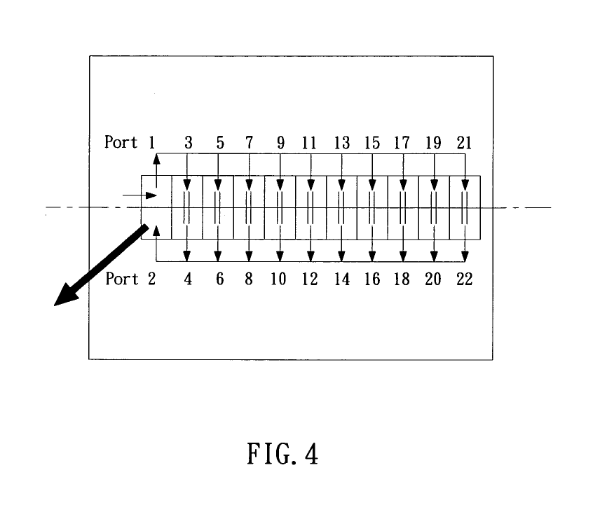

Referring to FIG. 4, a schematic diagram illustrating a relationship between the port configuration and a data flow of the switch according to the above embodiment of the present invention is depicted therein. When a data packet is received by the input port, i.e. port 1, the data packet may be broadcasted to the non-input ports in VLAN1 (i.e. port 3, port 5, . . . , port 21). Upon receiving the data packet from port 1, each of the non-input ports in VLAN1 transmits the received data packet to a corresponding one of the non-output ports in VLAN2 (i.e. port 4, port 6, . . . , port 22, in respective), where each of the non-output ports in VLAN2 further transmits the received data packet to the output port, i.e. port 2 so that the output port can transmit the plural received data packets to outside. In such a manner, the volume of data flow is increased.

In the embodiments of the invention, the volume of data flow may be increased to a specific time depending on the non-output ports in VLAN2. In this embodiment, the non-output ports in VLAN2 total 10 and thus ten times the data flow at the input port is obtained at the output port. In a further embodiment, each the non-input ports in VLAN1 is capable of corresponding to more than one of the non-output ports in VLAN2 and thus a larger data flow multiplication effect may be achieved.

Further, the switch of this invention may be used in series. That is, when two identical thus configured switches are connected in series, 100 times the data flow at the input port may be achieved.

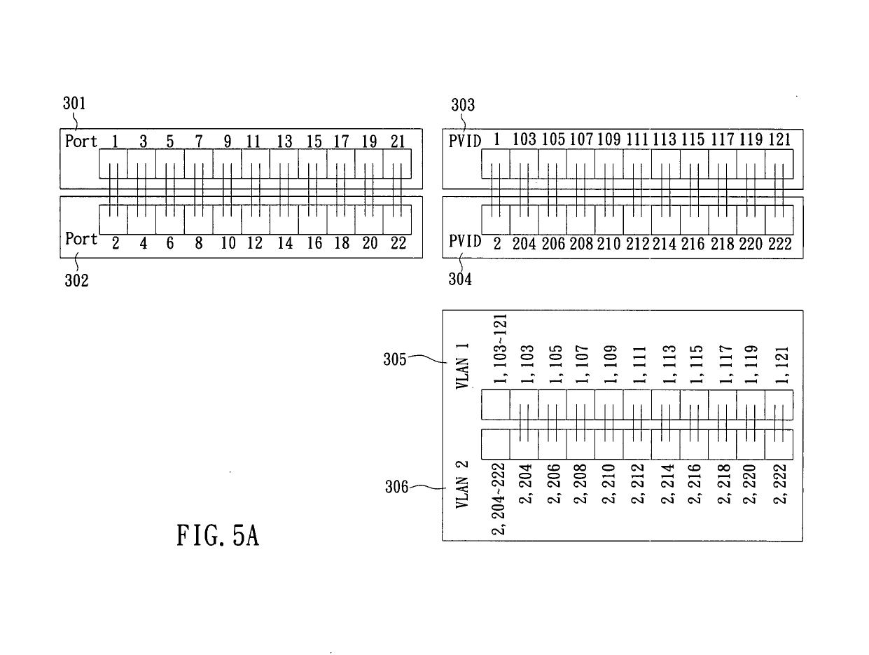

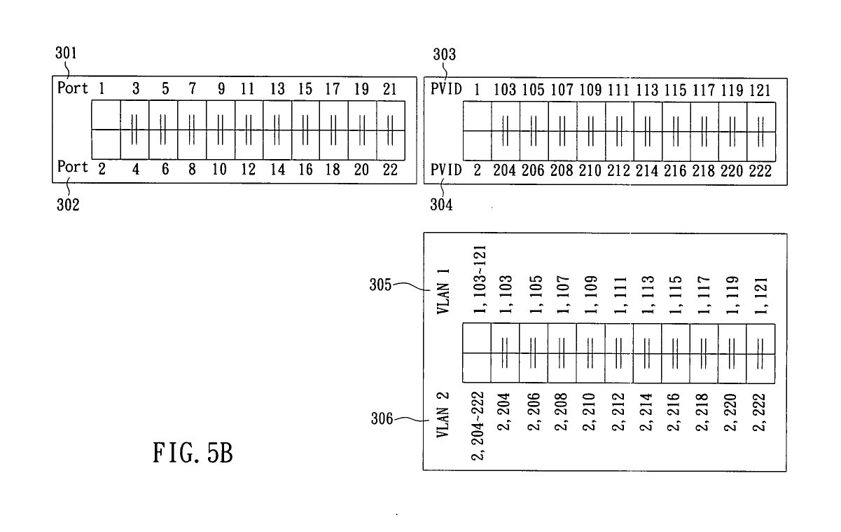

Referring to FIG. 5A, a schematic diagram illustrating the relationship between the port configuration and the volume of data flow of the switch according to another embodiment of the present invention is depicted therein. As shown, a first switch 301 having 11 ports is connected in series with a second switch 302 having 11 ports. The plural ports of the first switch 301 are grouped in a VLAN1 305 and are designated with a plurality of connection port virtual identification codes (PVIDs) 303 in respective, and the plural ports of the second switch 302 are grouped in a VLAN2 306 and are designated with a plurality of PVIDs 304 in respective. Such a setting makes the ports to act as a logical network where workstations not physically connected one another are logically connected so that communications between these workstations may be feasible just like those among physically connected workstations. Since many VLANs may be present in networking space concurrently, each VLAN is required to possess a particular PVID so that the VLAN may be uniquely identified, such as the PVID 303 for the VLAN1 305 and the PVID 304 for the VLAND2 306. In this embodiment, VLAN1 305 and VLAN 306 are considered as the first segment 305 and the second segment 306 in respective. The detailed configuration of the VLAN1 305 and VLAND2 306 are described as follows.

In the first segment, 11 ports are included with port 1 being assigned as an input port and the other ports, i.e. port 3, 5, . . . , 21, being assigned as members of the VLAN1 305, while the PVID corresponding to the input port, i.e. port 1, is assigned to be 1 and the PVIDs corresponding to the port 3, 5, . . . , and 21 are respectively assigned as 103, 105, . . . , 121. Namely, port 3 in the first segment corresponds to the PVID of 1 and 103, port 5 in the first segment corresponds to the PVID of 1 and 105, . . . , and port 21 corresponds to the PVID of 1 and 121. The same analogy may be deduced for the other ports in the same portion. Thus, as the ports 3, 5, . . . , 21 are all being grouped into the first segment, i.e. VLAN1 305, the PVID assigned to the input port, i.e. port 1, will be 1, 103, 105, . . . , 121.

In the second segment, 11 ports are included with port 2 being assigned as an output port and the other ports, i.e. port 4, 6, . . . , 22, being assigned as members of the VLAN2 306, while the PVID corresponding to the output port, i.e. port 2, is assigned to be 2 and the PVIDs corresponding to the port 4, 6, . . . , and 22 are respectively assigned as 204, 206, . . . , 222. Namely, port 4 in the second segment corresponds to the PVID of 2 and 204, port 6 in the second segment corresponds to the PVID of 2 and 206, . . . , and port 22 corresponds to the PVID of 2 and 222, in addition, port 3 is connected with port 4, port 5 is connected with port 6, . . . , and port 21 is connected to port 22, and the rest may be deduced by analogy. Thus, the ports 4, 6, . . . , 22 are all being grouped into the second segment, i.e. VLAN2 306, the PVID assigned to the output port, i.e. port 2, will be 2, 204, 206, . . . , 222.

When a set of data is inputted from the input port in the first segment, all the non-input ports of the first segment will receive the data since port 1 has the default PVID of 1 so as to enable all the non-input ports of VLAN1 305 having PVID 1 to receive a copy of the data. Further, since the non-input ports of the first and the non-output ports of the second segments may be corresponded to each other, all the non-input ports in the second segment will PVID corresponding to 2 will receive the data packet and thus the output port of the second segment will receive the plural sets of data transmitted from all the non-output ports in VLAN2 306 since the PVID assigned to the output port is 2, 204, 206, . . . , 222.

From the above description, the output port of the second segment, i.e. port 2, will receive ten times of the set of data inputted from the input port of the first segment and further outputs the same. In such a manner, the volume of data flow is increased by ten times.

Referring to FIG. 5B, a schematic diagram illustrating the relationship between the amount of data flow and the port configuration of the switch according to yet another embodiment of the present invention is shown therein. The switch is also divided into a first segment 301 (an upper line as shown) and a second segment 302 (a lower line as shown). In the first segment 301, a plurality of PVIDs 303 are set to establish a first VLAN 305. Likewise, a plurality of PVIDs 304 are set in the second segment 302 to establish a second VLAN 306. Other successive settings of the ports in the first and second segments 301, 302 are described as follows. Consequently, the purpose of data flow increasing of ten times may also be achieved by a single switch.

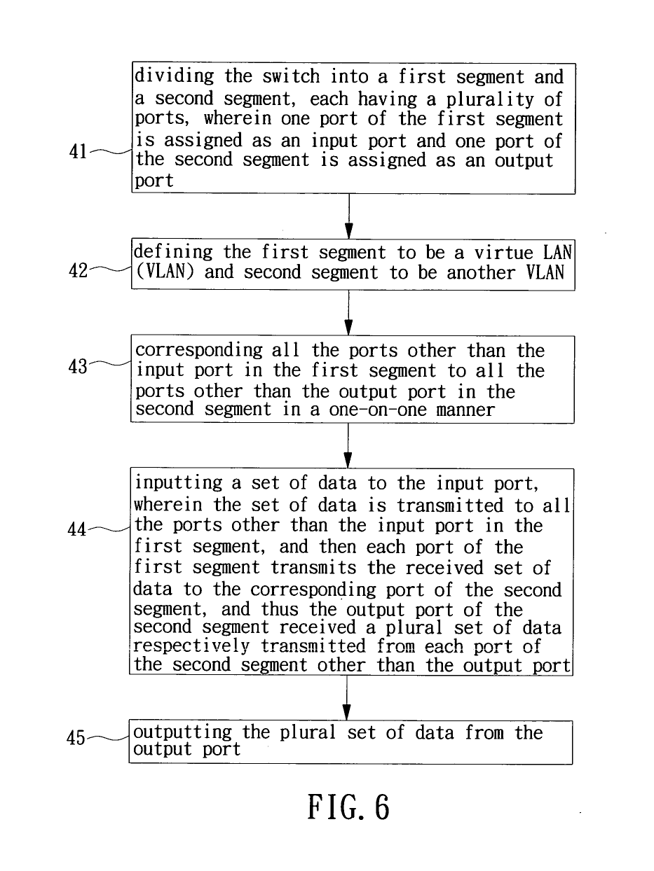

Referring to FIG. 6, a flowchart of a method for increasing data flow according to the present invention is shown therein, where the above described principle is summarized. The method comprises the steps of:
(41) dividing the switch into a first segment and a second segment, each having a plurality of ports, wherein one port of the first segment is assigned as an input port and one port of the second segment is assigned as an output port;
(42) defining the first segment to be a virtual LAN (VLAN) and second segment to be another VLAN;
(43) corresponding all the ports other than the input port in the first segment to all the ports other than the output port in the second segment in a one-on-one manner;
(44) inputting a set of data to the input port, wherein the set of data is transmitted to all the ports other than the input port in the first segment, and then each port of the first segment transmits the received set of data to the corresponding port of the second segment, and thus the output port of the second segment received a plural set of data respectively transmitted from each port of the second segment other than the output port; and
(45) outputting the plural sets of data from the output port

With the switch and the method disclosed above, the purpose of data flow increasing is actually achieved by duplicating a data packet in manners as described and the result of a speed of at least tens time of the data flow is obtained. (lose some description)

While this invention has thus far been described in connection with the preferred embodiments thereof, it will readily be possible for those skilled in the art to put this invention into practice in various other manners without departing from the scope set forth in the appended claims.

1. A method of configuring at least a switch for duplicating a data packet and enabling the switch to output a plural duplicated data packets at a speed and volume qualifying for testing a device-under-test, the method comprising the steps of:
(a) dividing the switch into a first segment and a second segment, each having a plurality of ports, wherein one port of the first segment is assigned as an input port and one port of the second segment is assigned as an output port;
(b) defining the first segment to be a virtual LAN (VLAN) and second segment to be another VLAN;
(c) corresponding all the ports other than the input port in the first segment to all the ports other than the output port in the second segment;
(d) inputting a set of data to the input port, wherein the data packet is transmitted to all the ports other than the input port in the first segment, and then each port of the first segment transmits the received data packet to the corresponding port of the second segment, and thus the output port of the second segment received a plural duplications of the data packet respectively transmitted from each port of the second segment other than the output port; and
(e) outputting the plural received data packets at the output port.

2. The method as recited in claim 1, wherein each of the ports other than the input port in the first segment corresponds to at least one of the ports other than the output port in the second segment during the processing of the step (c).

3. The method as recited in claim 1, wherein the amount of duplicated data packet outputted from the output port of the second segment is dependent on the number of the ports other than the output port in the second segment being corresponded by the ports other than the input port in the first segment during the processing of the step (c).

4. The method as recited in claim 1, wherein the device-under-test is a hub.

5. The method as recited in claim 1, wherein the device-under-test is a switch.

6. The method as recited in claim 1, wherein the configuring process is accomplished by a software.

7. The method as recited in claim 1, wherein the switches are serial-connected while more than one switch is being configured.

8. A method of configuring at least a switch for duplicating a data packet and enabling the switch to output a plural duplicated data packets at a speed and volume qualifying for testing a device-under-test, the method comprising the steps of:
(a) dividing the switch into a first segment and a second segment, each having a plurality of ports, wherein one port of the first segment is assigned as an input port and one port of the second segment is assigned as an output port;
(b) assigning a plurality of port virtual IDs (PVIDs) respectively to each port of the first segment so as to establish a first virtual LAN (VLAN), and assigning a plurality of port virtual IDs (PVIDs) respectively to each port of the second segment so as to establish a second virtual LAN (VLAN) while enabling the input port to transmit the data packet to the other ports in the first segment basing on the assigned PVIDs of first VLAN, and the output port to be capable of receiving the data packets from the other ports in the second segment basing on the assigned PVIDs of second VLAN;
(c) corresponding all the ports other than the input port in the first segment to all the ports other than the output port in the second segment;
(d) inputting a set of data to the input port, wherein the data packet is transmitted to all the ports other than the input port in the first segment, and then each port of the first segment transmits the received data packet to the corresponding port of the second segment, and thus the output port of the second segment received a plural duplications of the data packet respectively transmitted from each port of the second segment other than the output port; and
(e) outputting the plural received data packets at the output port.

9. The method as recited in claim 8, wherein each of the ports other than the input port in the first segment corresponds to at least one of the ports other than the output port in the second segment during the processing of the step (c).

10. The method as recited in claim 8, wherein the amount of duplicated data packet outputted from the output port of the second segment is dependent on the number of the ports other than the output port in the second segment being corresponded by the ports other than the input port in the first segment during the processing of the step (c).

11. The method as recited in claim 8, wherein the device-under-test is a hub.

12. The method as recited in claim 8, wherein the device-under-test is a switch.

13. The method as recited in claim 8, wherein the configuring process is accomplished by a software.

14. The method as recited in claim 8, wherein the switches are serial-connected while more than one switch is being configured.
